(19) United States
(12) Patent Application Publication
(10) Pub. No.: US 2006/0231966 A1
(43) Pub. Date: Oct. 19, 2006

(54) Method for forming electrically conductive graphite concrete block

(76) Inventor: Tsai Ching Tsung, Taoyuan City (TW)

Correspondence Address: PRO-TECTOR INTERNATIONAL SERVICES, 20775 NORADA CT., SARATOGA, CA, 95070, US

(21) Appl. No.: 11/388,342

(22) Filed: Mar. 23, 2006

(30) Foreign Application Priority Data
Apr. 18, 2005 (CN) 200510064446.1

(51) Int. Cl. C04B 35/00

(52) U.S. Cl. 264/86; 264/105

(57) ABSTRACT

A method for forming an electrically conductive graphite concrete block includes mixing cement, sands, stones, electrically conductive graphite powders, and water and stirring the mixture to form graphite concrete slurry; filling the graphite concrete slurry into a mold chamber of a mold device, with two electrodes formed on a surface of the graphite concrete slurry; pressing the graphite concrete slurry with high pressure to drain liquid in the graphite concrete slurry to form a blank for an electrically conductive graphite concrete block; opening the mold device to release the blank; and placing the blank statically for a period of time to form an electrically conductive graphite concrete block. Preferably, the mold device includes a bottom board including a plurality of drain holes. A sieve device is mounted above the drain holes, allowing the liquid in the graphite concrete slurry to drain via the sieve device and the drain holes.

### BACKGROUND OF THE INVENTION

1. Field of the Invention

The present invention relates to a method for forming a graphite concrete block. More particularly, the present invention relates to a method for forming an electrically conductive graphite concrete block.

2. Description of the Related Art

A typical electrically conductive graphite concrete block is generally used in architecture including buildings and bridges and electrically connected to an external power source for conducting electricity and generating heat. In manufacture, cement, sands, stones, and graphite powders are mixed and water are added and stirred for subsequently forming a conductive layer on a surface (such as the ground) of an architecture structure.

Since the conductive layer contains graphite powders that are necessary for electrical conduction, the structural strength is reduced. In addition to an increase in the cost, the structural strength is dramatically reduced when more graphite powders are contained. Hence, the electrically conductive graphite concrete can only be used in architecture, not applicable to household electronic devices, medical field, industry, and agriculture.

### SUMMARY OF THE INVENTION

An objective of the present invention is to provide a method for forming an electrically conductive graphite concrete block with high strength and excellent conductivity.

Another objective of the present invention is to provide a method for forming an electrically conductive graphite concrete block that can be used not only in architecture but also in household electronic devices, medical field, industry, and agriculture.

A method for forming an electrically conductive graphite concrete block in accordance with the present invention comprises mixing cement, sands, stones, electrically conductive graphite powders, and water and stirring the mixture to form graphite concrete slurry; filling the graphite concrete slurry into a mold chamber of a mold device, with two electrodes formed on a surface of the graphite concrete slurry; pressing the graphite concrete slurry with high pressure to drain liquid in the graphite concrete slurry to form a blank for an electrically conductive graphite concrete block; opening the mold device to release the blank; and placing the blank statically for a period of time to form an electrically conductive graphite concrete block.

Preferably, the mold device comprises a bottom board including a plurality of drain holes. A sieve device is mounted above the drain holes, allowing the liquid in the graphite concrete slurry to drain via the sieve device and the drain holes.

Preferably, the mold device further comprises a top board and four side boards that define the mold chamber.

Preferably, the sieve device comprises a plurality of layers of sieves. A mesh number of an upper one of the sieves is greater than that of a lower one of the sieves.

Preferably, the liquid is drained by pumping operation.

Preferably, the mold device further comprises a frame attached to the bottom board.

Preferably, the pressure applied to the graphite concrete block is gradually increased to a maximum value of about 90-120 kg/cm² in the step of pressing the graphite concrete slurry.

Other objectives, advantages, and novel features of the invention will become more apparent from the following detailed description when taken in conjunction with the accompanying drawings.

### BRIEF DESCRIPTION OF THE DRAWINGS

FIG. 1 is a flowchart illustrating a method for forming an electrically conductive graphite concrete block in accordance with the present invention.

FIG. 2 is a sectional view of a mold device for forming an electrically conductive graphite concrete block in accordance with the present invention.

FIG. 3 is a sectional view illustrating operation of the mold in FIG. 2.

FIG. 4 is an exploded perspective view of a sieve device of the mold device in FIG. 2.

FIG. 5 is a sectional view illustrating a modified embodiment of the mold device for forming an electrically conductive graphite concrete block in accordance with the present invention.

### DETAILED DESCRIPTION OF THE PREFERRED EMBODIMENTS

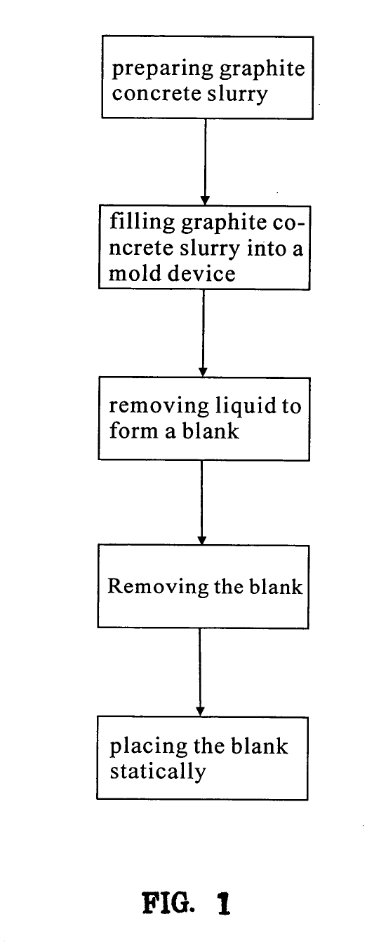

Referring to FIG. 1, a method for forming an electrically conductive graphite concrete block in accordance with the present invention comprises preparing graphite concrete slurry, feeding the graphite concrete slurry into a mold device, removing liquid out of the graphite concrete slurry to form of a blank for an electrically conductive graphite concrete block, opening the mold device and removing the blank, and placing the blank statically for a period of time to form an electrically conductive graphite concrete block.

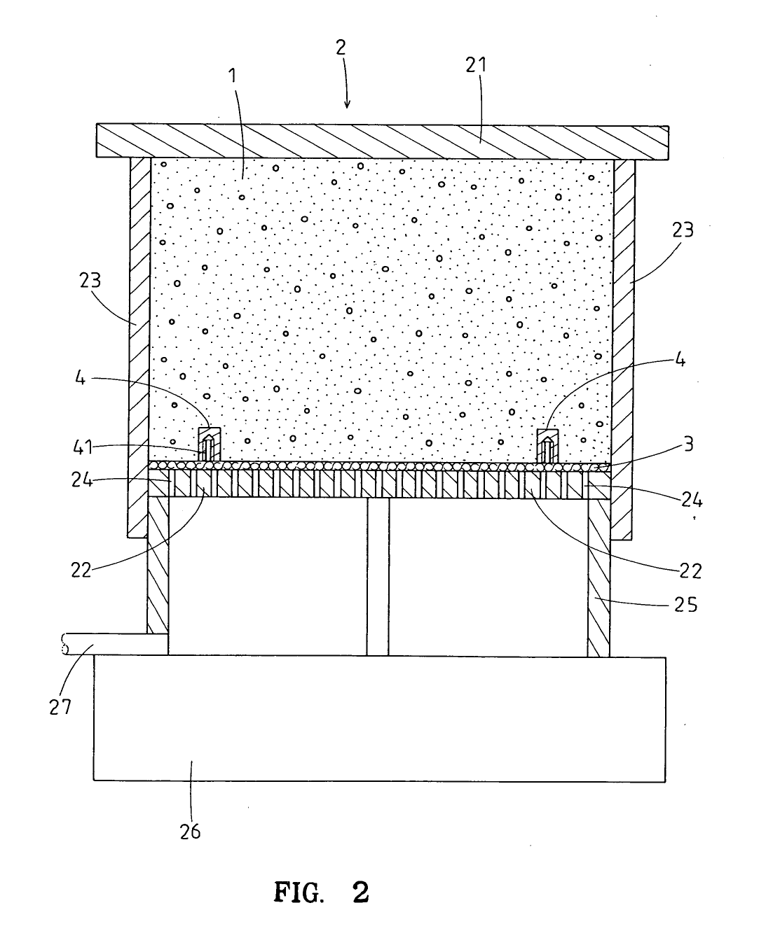

More particularly, referring to FIGS. 1 and 2, cement, sands, stones (such as pebbles and/or gravels), and electrically conductive graphite powders are added with water and stirred to form graphite concrete slurry (step 10). The graphite concrete slurry is filled into a mold chamber of a mold device 2, and two electrodes 4 are formed on a surface of the graphite concrete slurry (step 12). The graphite concrete slurry is then pressed with high pressure to remove liquid in the graphite concrete slurry to form a blank 11 for an electrically conductive graphite concrete block (step 14). The mold device is opened to release the blank (step 16). The blank is placed statically for a period of time to form an electrically conductive graphite concrete block (step 18).

Referring to FIG. 2, the mold device 2 comprises a top board 21, a bottom board 22, and four side boards 23, forming a mold chamber for receiving the graphite concrete slurry. Two electrodes 4 are provided on a surface of the graphite concrete slurry. Each electrode 4 includes a screw hole 41 that is not blocked. The bottom board 22 includes a plurality of drain holes 24 and a sieve device 3 is placed above the drain holes 24. Preferably, each drain hole 24 has a diameter of about 2-10 mm.

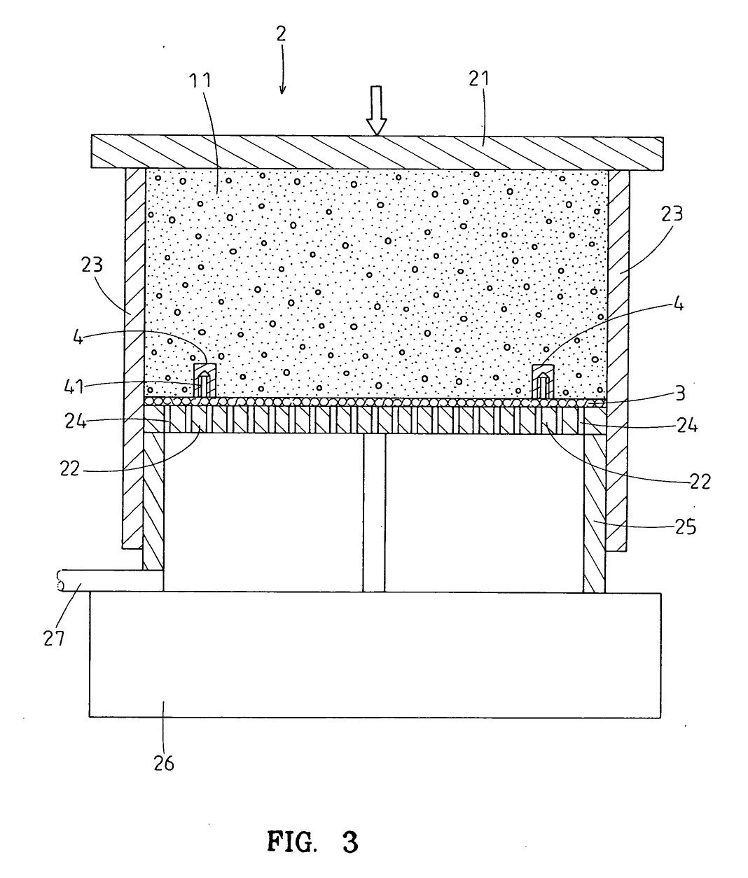

In this example, the bottom board 22 is fixed, and the four side boards 23 are fixed to the top board 21, forming a mold chamber with a bottom opening closed by the bottom board 22. The top board 21 and the four side boards 23 are mechanically or manually moved downward to drain the graphite concrete slurry 1, as shown in FIG. 3. The liquid in the graphite concrete slurry is drained outside after passing through the sieve device 3 and the drain holes 24. The pressure applied to the graphite concrete slurry for removing the liquid is preferably increased gradually.

The maximum pressure for forming an electrically conductive graphite concrete block with a thickness of 20 mm is about 90-120 kg/cm² and lasts for about 4-10 seconds. The pressure is released after no liquid is drained. A blank 11 for an electrically conductive graphite concrete block is formed. The mold device 2 is opened to release the blank 11, which, is then placed statically for a period of time (such as 28 days) to form an electrically conductive graphite concrete block with high strength and excellent conductivity.

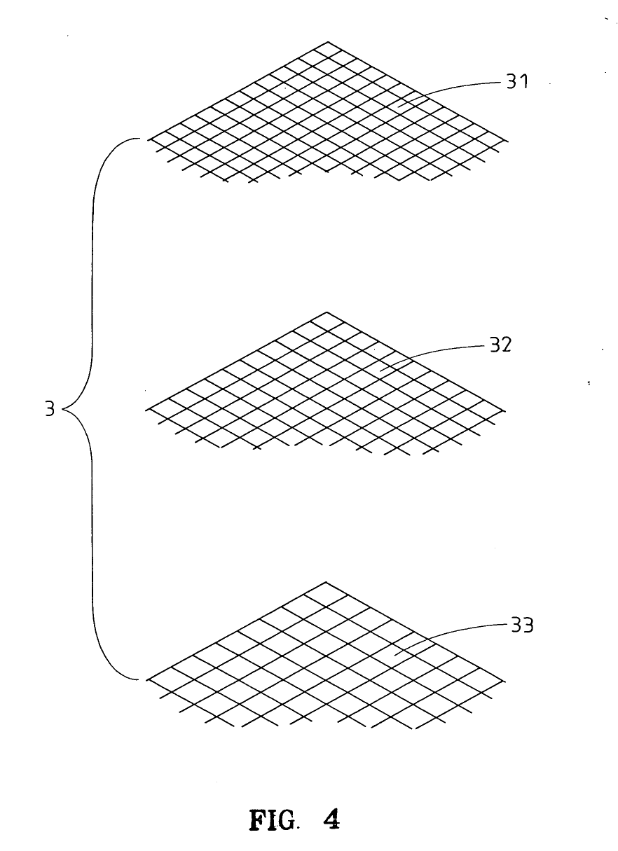

Referring to FIGS. 2 and 4, the sieve device 3 includes two or three layers of sieves 31, 32, and 33. The number of meshes of an upper sieve is greater than that of the meshes of a lower sieve. In this example, the three sieves 31, 32, and 33 include 120-170, 80-120, and 32-80 meshes, respectively. In a case that only two layers of sieves are used, the upper sieve may include 100-120 meshes and the lower sieve may include 80-100 meshes. The sieve device 3 with multiple layers of sieves while prevents leakage of solid contents of the graphite concrete slurry while allowing drainage of liquid (such as water).

During the pressing/formation process, a positioning structure is provided around each metal electrode 4 so that each metal electrode 4 is fixedly combined with the graphite concrete block as an integral member. Each electrode 4 has a high strength, and the screw hole 41 in each electrode 4 assures reliable connection with an external power line.

Still referring to FIG. 3, the mold device 2 may further include a frame 25 attached to the bottom board 22 and defining a chamber that is in communication with outside via an exhaust pipe 27 connected to an air pump (not shown) or the like. This allows the liquid to be drained via pumping operation.

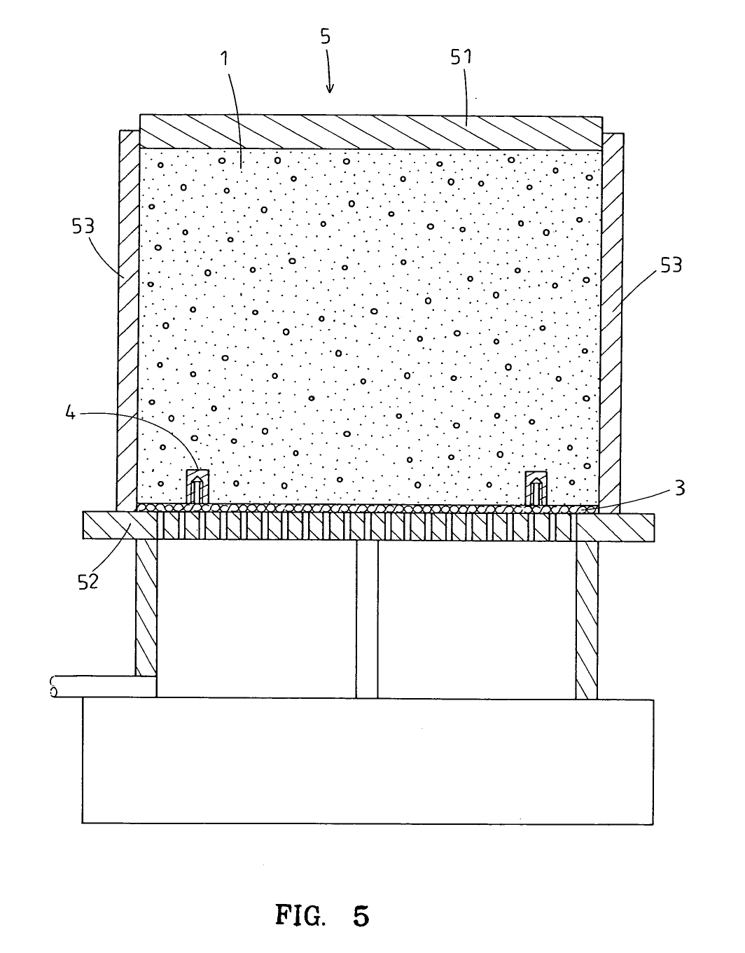

FIG. 5 illustrates a modified embodiment of the mold device (now designated by 5) in accordance with the present invention. In this example, the mold device 5 comprises a movable top plate 51 and a fixed bottom plate 52, yet the side boards 53 are fixed to the bottom plate 52.

The following Table 1 shows the properties of three examples of the present invention, three comparative examples, and an ordinary concrete block made by current grouting technique. It is noted that in the three examples of the present invention, the electrically conductive graphite concrete blocks are formed by placing blanks statically for 28 days.

TABLE 1

| | graphite | | | | | | | pressive |
|---|---|---|---|---|---|---|---|---|
| | content | graphite | cement | sand | pebble | water | resistivity | strength |
| | (W %) | (g) | (g) | (g) | (g) | (g) | (Ω · m) | (MP) |
| Ordinary concrete block | 0 | 0 | 414 | 702 | 1112 | 160 | 1.01 × 10⁵ | 43.7 |
| Comparative example 1 | 4.82 | 119.4 | 414 | 582.6 | 1112 | 246 | 117.19 | 7.6 |
| Comparative example 2 | 9.32 | 238.8 | 414 | 463.2 | 1112 | 332 | 25.89 | 3.5 |
| Comparative example 3 | 13.53 | 358.2 | 414 | 343.8 | 1112 | 418 | 1.75 | 1.7 |
| Example 1 | 3.59 | 87.2 | 414 | 614.8 | 1112 | 183 | 4.10 | 70 |
| Example 2 | 4.05 | 99.4 | 414 | 602.6 | 1112 | 207 | 1.06 | 70 |
| Example 3 | 4.82 | 119.4 | 414 | 582.6 | 1112 | 246 | 0.53 | 70 |

In the conductive graphite concrete blocks of the three comparative examples made by current grouting technique, the resistivity decreases when the graphite content increases. Nevertheless, experiment results show that the resistivity remains unchanged when the graphite content is greater than about 15%. The resistivity is 1.38 when the graphite content is 20%. Experiment results also show that the longer the period of time the blanks are placed, the greater the resistivity is. Nevertheless, the resistivity increasing rate decreases gradually. For example, given that the graphite content is 4.82%, the resistivity is 117.36 if the blank is placed for 56 days. Nevertheless, the pressive strength decreases linearly when the graphite content increases. Experiment results show that the pressive strength is very low when the graphite content exceeds about 15%. In an example, the pressive strength is 0.269 MP when the graphite content is 20%.

In the conductive graphite concrete blocks of the three examples of the present invention, the resistivity decreases dramatically when the graphite content increases by a small amount. Experiment results show that the resistivity is very small when the graphite content is greater than about 5%. Experiment results also show that the resistivity is increased by a relatively small value even though the blanks are placed for a relatively long period of time whereas the passive strength remains unchanged when the graphite content increases. Experiment results further show that the pressive strength may reach up to 60 MP after the blanks are placed for 7 days.

Given the graphite content is 4.82%, the resistivity of an ordinary graphite concrete block (Comparative example 1) made by current grouting technique is 117.19, which is 221 times as large as the resistivity (0.53) of a graphite concrete block (Example 3) made by the method in accordance with the present invention. Further, the pressive strength of Comparative example 1 made by current grouting technique is 10.9% of that of Example 3 made by the method in accordance with the present invention. Thus, when using the method of the present invention to form an electrically conductive graphite concrete block, a large amount of graphite can be saved while providing high passive strength for the graphite concrete block (about 1.6 times of an ordinary concrete without graphite). The electrically conductive graphite concrete block formed by the method in accordance with the present invention can be used not only in architecture but also in household electronic devices, medical field, industry, and agriculture.

Although specific embodiments have been illustrated and described, numerous modifications and variations are still possible without departing from the essence of the invention. The scope of the invention is limited by the accompanying claims.

What is claimed is:

1. A method for forming an electrically conductive graphite concrete block, comprising:
mixing cement, sands, stones, electrically conductive graphite powders, and water and stirring the mixture to form graphite concrete slurry;
filling the graphite concrete slurry into a mold chamber of a mold device, with two electrodes formed on a surface of the graphite concrete slurry;
pressing the graphite concrete slurry with high pressure to drain liquid in the graphite concrete slurry to form a blank for an electrically conductive graphite concrete block;
opening the mold device to release the blank; and
placing the blank statically for a period of time to form an electrically conductive graphite concrete block.

2. The method as claimed in claim 1 wherein the mold device comprises a bottom board including a plurality of drain holes, further comprising a sieve device mounted above the drain holes, allowing the liquid in the graphite concrete slurry to drain via the sieve device and the drain holes.

3. The method as claimed in claim 2 wherein the mold device further comprises a top board and four side boards that define the mold chamber.

4. The method as claimed in claim 2 wherein the sieve device comprises a plurality of layers of sieves, a mesh number of an upper one of the sieves being greater than that of a lower one of the sieves.

5. The method as claimed in claim 1 wherein the liquid is drained by pumping operation.

6. The method as claimed in claim 5 wherein the mold device further comprises a frame attached to the bottom board.

7. The method as claimed in claim 1 wherein the pressure applied to the graphite concrete block is gradually increased to a maximum value of about 90-120 kg/cm² in the step of pressing the graphite concrete slurry.
